(19) United States
(12) Patent Application Publication
(10) Pub. No.: US 2006/0151746 A1
(43) Pub. Date: Jul. 13, 2006

(54) Fluorescent substance for low voltage exciting source and manufacturing methods thereof

(76) Inventors: Ru-Shi Liu, Hsinchu County (TW); Chia-Chen Kang, Taipei City (TW); Whe-Yi Chiang, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/032,120

(22) Filed: Jan. 11, 2005

(51) Int. Cl. C09K 11/54

(52) U.S. Cl. 252/301.4 F; 252/301.6 F

(57) ABSTRACT

The present invention discloses a fluorescent substance for low voltage exciting source, wherein the host lattice of the fluorescent substance is composed of metal ions and silica, and the host lattice is further doped with activator. Furthermore, the general formula of the fluorescent substance is (Sr_{2-x-y}MₓEu_{y})SiO₄ (x≧0, y>0, x+y<2), wherein M comprises at least one kind of metal ion except Sr or Eu. The wavelength of the light emitted from the fluorescent substance can be shifted by introducing M into the lattice structure, so that the provided fluorescent substance is able to emit lights with various colors from yellow to yellow-green. Additionally, the provided fluorescent substance with single phase can be fabricated in a variety of methods, such as solid state reaction method, co-precipitation method, gel method and micro emulsion method.

### BACKGROUND OF THE INVENTION

1. Field of the Invention

The present invention is generally related to fluorescent substances, and more particularly to fluorescent substance for low voltage exciting source which can be applied in field emission display, photocells excited by electrons or plasma, or any light source with fluorescent substances. The present invention also disclosed the manufacturing method of the fluorescent substance for low voltage exciting source.

2. Description of the Prior Art

The global market for flat panel displays (FPDs) was estimated at 18.5 billion dollars in sales in 1999, and the market is predicted to reach $70 billion by the year 2010. The tremendous growth in FPD popularity is due largely to the improvements in quality and cost reduction of liquid crystal displays (LCDs). Other types of FPDs are also increasingly finding their way to the customer showrooms. These include plasma and projection displays, aimed at the high end, large area home entertainment and commercial display systems, as well as organic light emitting displays, with high-volume mass market applications in cell phones, personal digital assistant (PDA), vehicle information processor (VIP) and digital cameras. For reasons of weight, volume and health, the marker share of FPDs are getting higher and higher. Given the magnitude and growth potential of the display market, it is not surprising that alternative FPD technologies continue to attract investment because they hold the promise of surpassing LCDs in price, performance, and scalability. One of the attractive technologies is field emission display (FED). The FED is a vacuum electron device, sharing many common features with the cathode-ray tube (CRT). In a FED the electron source consists of a matrix-addressed array of millions of cold emitters. This field emission array (FEA) is placed in close proximity (0.2-2.0 mm) to a phosphor faceplate and is aligned such that each phosphor pixel has a dedicated set of field emitters. Although FED is very similar to a thin CRT in appearance, the operational potential of FED is much lower (≦1 kV) than CRT (15-30 kV).

The first operating FEAs were demonstrated by Capp Spitindt. He successfully applied semiconductor based manufacturing methods to fabricating arrays of micron-sized, self-aligned metal cones, each surrounded by a metal gate (called Spindt-type emitter). Despite the many advantages of the Spindt-type FEA fabrication technique, scaling this method to large area substrate (>400 mm on the side) is still a major challenge. Additionally, the Spindt tips are easy worn down, which results in a consequent shorter lifetime. Graphite with naro-structure or carbon nanotube has been found suitable to be used as field emitters because of their low turn-on potential. Currently, carbon nanotube field emission display (CNT-FED) has attracted great interest on research.

On the other hand, another important issue in FED is fluorescent substance which is able to decide the colors and luminous efficiency of the FED. Researches in this field are still in their initial stages. Since 1998, Samsung has applied numbers of patents about fluorescent substances and claimed high luminous efficiency thereof, these fluorescent substances include ZnS, (Zn, Cd)S, ZnS: Zn, ZnS: Ag, [(Zn,Cd)S: Ag, Cl], ZnGa₂O₄, ZnGa₂O₄: Bi, SrTiO₃: RE and Y₂SiO₅ based compounds. (such as: U.S. Pat. No. 5,068,157, U.S. Pat. No. 6,152,965, U.S. Pat. No. 6,322,725, U.S. Pat. No. 6,416,688, U.S. Pat. No. 6,440,329, U.S. Pat. No. 6,641,756, US2003197460, EP0882776, EP1052276 and FR2800509). Additionally, Futaba Denshi Koggo (Japan) also applied several patents about low voltage fluorescent substances, these fluorescent substances include SrTiO₃: Pr, [ZnGa₂O₄: Li, P], [(Zn,Cd)S: Ag, Cl] and La₂O₂S: RE based compounds.

At present, most commercial FED utilizes P22-type fluorescent substances, wherein the blue fluorescent substance is (ZnS: Ag, Cl), the green fluorescent substance is (ZnS: Cu, Au, Al) and the red fluorescent substance is Y₂O₂S: Eu. The most common application of the P22-type fluorescent substances is for CRT displays, and when being used for CRT displays, the P22-type fluorescent substances are covered with an aluminium layer. However, when being used for FED the P22-type fluorescent substances are not covered with the aluminium layer, in order to keep a low working voltage. Therefore, lifetime of FED will be dramatically reduced because of deterioration of fluorescent substances, contamination of cathode and reduction of vacuum degree. Most of P22-type fluorescent substances are sulfide-based, they are less adaptive to environmental variations than oxide-based fluorescent substances. This makes the P22-type fluorescent substances less stable than those oxide-based fluorescent substances. Further, efficiency of luminescence of the P22-type fluorescent substances is reduced in an FED driven by low voltage.

### SUMMARY OF THE INVENTION

In accordance with the present invention, a new fluorescent substance is provided that substantially overcomes the drawbacks of the above problems mentioned from the conventional system, and can be applied in FED industries. One object of the present invention is to disclose a fluorescent substance for low voltage exciting source, wherein the host lattice of the fluorescent substance is composed of metal ions and silica, and the host lattice is further doped with activator. Furthermore, the wavelength of the light emitted from the fluorescent substance can be shifted by introducing M into the lattice structure, so that the provided fluorescent substance is able to emit lights with various colors from yellow to yellow-green. Another object of the present invention is to provide an oxide-based fluorescent substance which imparts, comparing to sulfide-based fluorescent substances, more stable structure, more saturated colors, and higher luminous efficiency. Moreover, the oxide-based fluorescent substances provided in the present invention can be applied as phototubes excited by electrons or plasma or light source emitting fluorescence.

The general formula of the provided fluorescent substance is (Sr_{2-x-y}MₓEu_{y})SiO₄ (x≧0, y>0, x+y<2), wherein M comprises at least one kind of metal ion except Sr or Eu. Besides, Sr₂SiO₄ is the host lattice, and Eu is the activator in the structure. In this invention, the major structure of the fluorescent substance and the surrounding electronic field of the activator can be adjusted by varying the radius of the metal ions, and then the crystal field interaction of the mentioned fluorescent substance is modulated. Thus, the interaction from the crystal field to the energy level of the activator is also changed. Besides, the splitting of the 5d orbital energy level of Eu ion of the activator is varied with the radius of the metal ions. The electronic configuration of Eu²⁺ is [Xe]4f⁷, wherein 4f orbital of Eu²⁺ splits into several energy levels by spin-orbital coupling, and 5d orbital of Eu²⁺ splits by crystal field interaction. According to FIG. 1, when Sr₂SiO₄:Eu is doped with metal ions with bigger radius, the crystal field interaction decreases, so as to decrease 5d orbital splitting, and then the released energy from excited electron jumped from 5d orbital to 4f orbital increases, thus the wavelength of emitted lights is blue-shifted, and vice versa. To sum up, this invention replace Sr in the host lattice Sr₂SiO₄ with metal ions from IIA group with two charges. By using metal ions with different radius to adjust the crystal field interaction, so that the provided fluorescent substance is able to emit lights with various wavelengths.

### BRIEF DESCRIPTION OF THE DRAWINGS

FIG. 1 is a diagram in accordance with a preferred embodiment of this present invention to show the energy level splitting of Eu ion in different states: free ion, Sr₂SiO₄:Eu and (Sr_{2-x-y}MₓEu_{y})SiO₄ (x≧0, y>0, x+y<2);

FIG. 2 is a emittion spectrum of (Sr_{1.84}Eu_{1.16})SiO₄ in accordance with a preferred embodiment of this present invention;

FIG. 3 is a emittion spectrum of (Sr_{1.44}Ba_{0.4}Eu_{0.16})SiO₄ in accordance with a preferred embodiment of this present invention; and

FIG. 4 is a CIE chromaticity diagram illustrating the transformed coordinates of original emittion spectrums of FIG. 2 and FIG. 3, respectively.

### DESCRIPTION OF THE PREFERRED EMBODIMENTS

What is probed into the invention is fluorescent substance for low voltage exciting source and manufacturing methods thereof. Detailed descriptions of the production, structure and elements will be provided in the following in order to make the invention thoroughly understood. Obviously, the application of the invention is not confined to specific details familiar to those who are skilled in the white lighting device. On the other hand, the common elements and procedures that are known to everyone are not described in details to avoid unnecessary limits of the invention. Some preferred embodiments of the present invention will now be described in greater detail in the following. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

In a preferred embodiment of this invention, there is provided a fluorescent substance for low voltage exciting source, wherein the general formula of the fluorescent substance is (Sr_{2-x-y}MₓEu_{y})SiO₄ (x≧=0, y>0, x+y<2), and M comprises at least one kind of metal ion except strontium (Sr) or europium (Eu). M further comprises any one or any combination of the following group: magnesium (Mg), calcium (Ca) and Barium (Ba). On the other hand, by replacement of Sr with M in the host lattice (Sr₂SiO₄), so that the wavelength of lights emitted from the fluorescent substance can be adjusted, thus the fluorescent substance is able to emit lights with various colors from yellow to yellow-green. Moreover, when the radius of M is bigger than that of Sr, the wavelength of lights emitted from the fluorescent substance is blue-shifted; when the radius of M is smaller than that of Sr, the wavelength of lights emitted from the fluorescent substance is red-shifted.

In this embodiment, the preparation method of the mentioned fluorescent substance is selected from the following group: solid state reaction method, co-precipitation method, gel method and micro emulsion method. Furthermore, the preparation method of the fluorescent substance comprises: performing a mixing process to mix raw materials, so as to form a mixture; and performing a sintering process to sinter said mixture. The sintering process further comprises a reduction step, wherein the reduction temperature ranges from 1200° C. to 1700° C., the reduction time ranges from 4 hrs to 24 hrs, and the environment for the reduction step comprises mixed hydrogen and nitrogen or mixed hydrogen and argon. Additionally, the low voltage exciting source is selected from a group consisting of the following: carbon nanotube emitter (CNT), surface conduction electron emitter (SED), ballistic electron surface emitter (BSD), metal insulator metal emitter (MIM) and the modifications thereof. On the other hand, the low voltage exciting source is equal to or less than 1 kV.

### Example 1

### (Sr_{1.84}Eu_{0.16})SiO₄

SrCO₃, SiO₂ and Eu₂O₃ according to the molar ratio in (Sr_{1.84}Eu_{0.16})SiO₄ are ground and well-mixed, and then a mixture is formed. Next, heating the mixture in the environment of H₂/N₂ (5%/95%) with increasing 5□ per minute to 1400 □, and staying at 1400 □ for 12 hours to reduce the mixture and form the product. Then, cooling the product with decreasing 5□ per minute to room temperature, and final product is fabricated.

### Example 2

### (Sr_{1.44}Ba_{0.4}Eu_{0.16})SiO₄

SrCO₃, BaCO₃, SiO₂ and Eu₂O₃ according to the molar ratio in (Sr_{1.44}Ba_{0.4}Eu_{0.16})SiO₄ are ground and well-mixed, thus a mixture is formed. Next, heating the mixture in the environment of H₂/N₂ (5%/95%) with increasing 50 per minute to 1400 □, and staying at 1400 □ for 12 hours to reduce the mixture and form the product, wherein Eu³⁺ is reduced to Eu²⁺ to increase the luminous efficiency of (Sr_{1.44}Ba_{0.4}Eu_{0.16})SiO₄. Then, cooling the product with decreasing 5□ per minute to room temperature, and final product is fabricated.

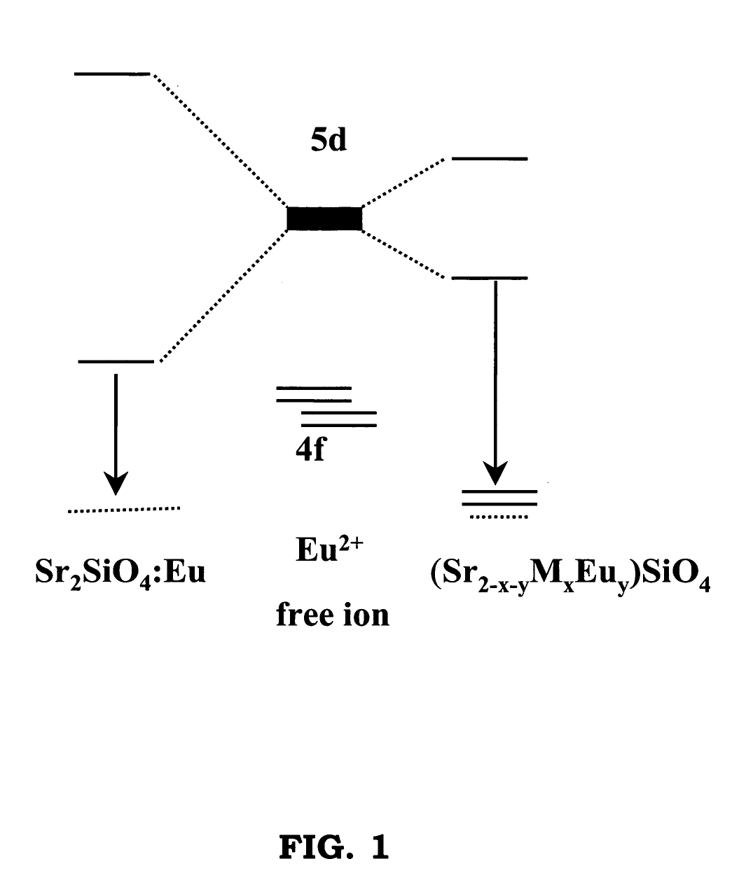

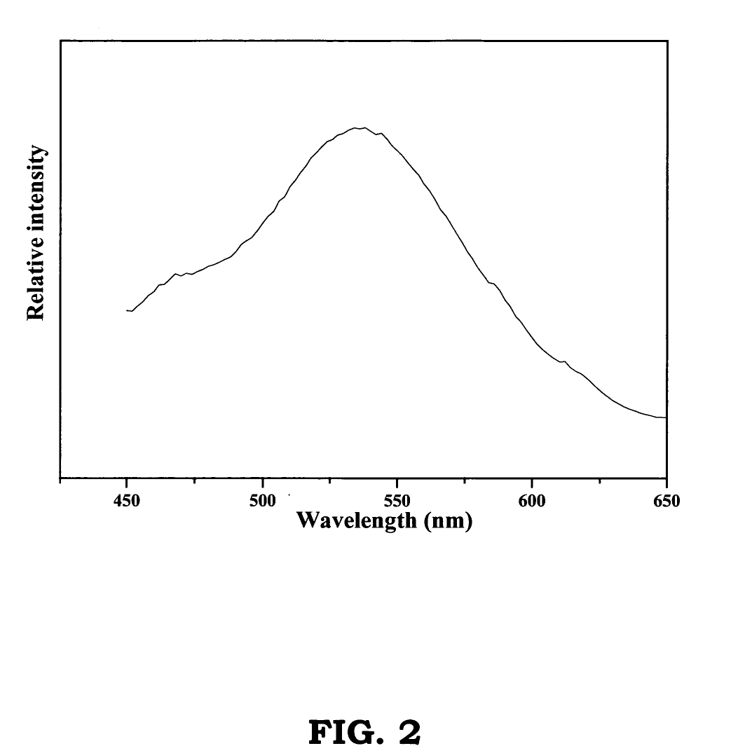

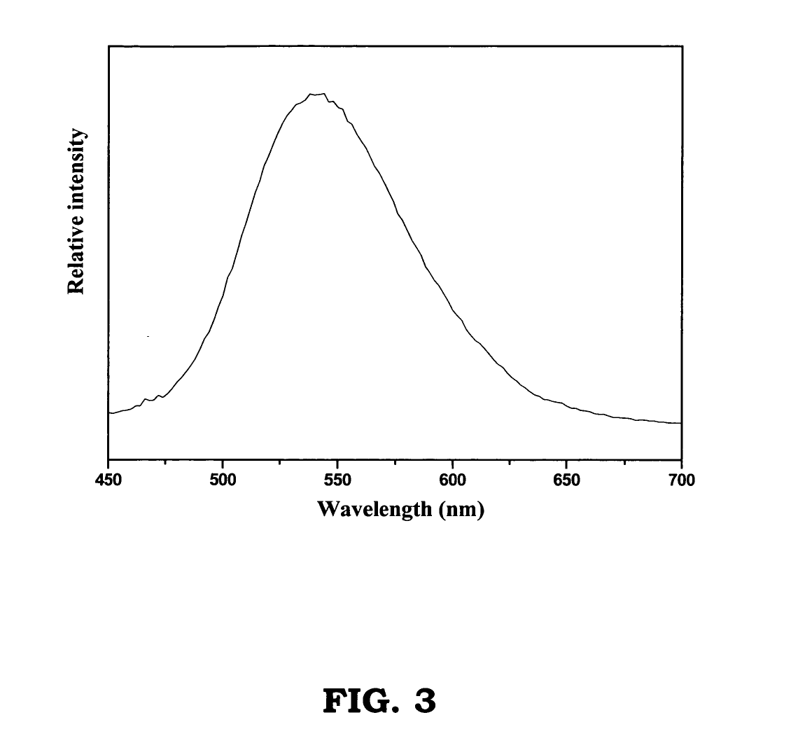

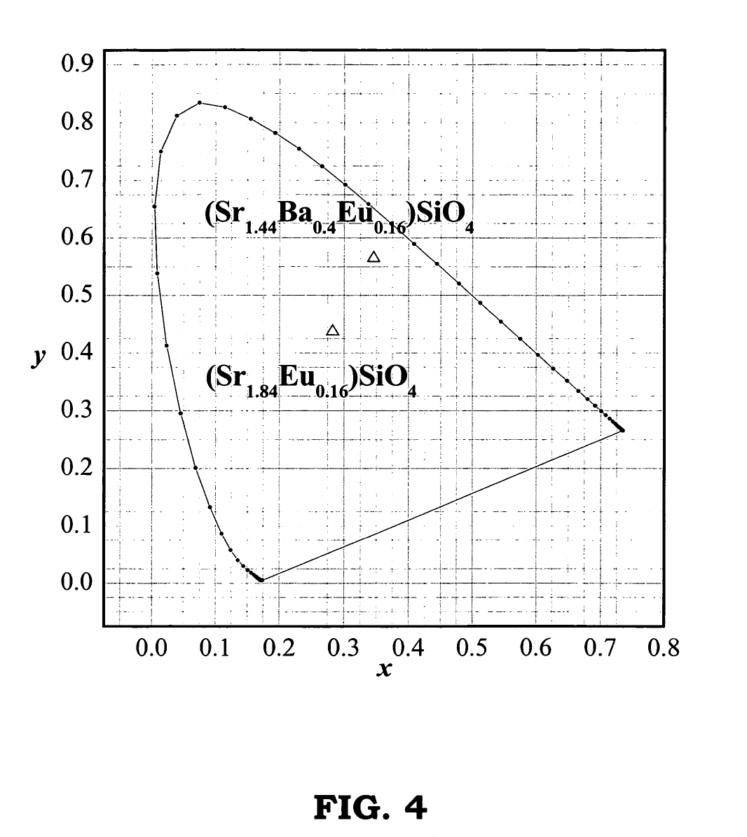

According to the embodiment of this present invention, the provided fluorescent substances (Sr_{1.84}Eu_{0.16})SiO₄ and (Sr_{1.44}Ba_{0.4}Eu_{0.16})SiO₄ respectively with single phase can be confirmed by X-ray diffraction. Moreover, FIG. 2 and FIG. 3 are the emittion spectrums of (Sr_{1.84}Eu_{0.16})SiO₄ and (Sr_{1.44}Ba_{0.4}Eu_{0.16})SiO₄ respectively in accordance with the embodiment of this present invention. Referring to FIG. 1 and FIG. 2, (Sr_{1.84}Eu_{0.16})SiO₄ is a fluorescent substance of yellow color, and (Sr_{1.44}Ba_{0.4}Eu_{0.16})SiO₄ is a fluorescent substance of yellow-green color. Next, as shown in FIG. 4, FIG. 2 and FIG. 3 are transformed to be shown on the chromaticity diagram according to the calculating formula established by Commission Internationale de l'Eclairage (CIE) in 1931. As shown in FIG. 4, there are two points, wherein one point's coordinate is x=0.2823, y=0.4369 indicating (Sr_{1.84}Eu_{0.16})SiO₄, and the other point's coordinate is x=0.3454, y=0.5651 indicating (Sr_{0.44}Ba_{0.4}Eu_{0.16})SiO₄.

Obviously many modifications and variations are possible in light of the above teachings. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

What is claimed is:

1. A fluorescent substance for low voltage exciting source, wherein the general formula of said fluorescent substance is (Sr_{2-x-y}MₓEu_{y})SiO₄ (x≧0, y>0, x+y<2), and M comprises at least one kind of metal ion except strontium (Sr) or europium (Eu).

2. The substance according to claim 1, wherein said M further comprises any one or any combination of the following group: magnesium (Mg), calcium (Ca) and Barium (Ba).

3. The substance according to claim 1, wherein said M replaces Sr in the host lattice (Sr₂SiO₄), so as to adjust the wavelength of lights emitted from the fluorescent substance, thus said fluorescent substance is able to emit lights with various colors from yellow to yellow-green.

4. The substance according to claim 1, wherein the radius of said M is bigger than that of Sr, so as to blue shift the wavelength of lights emitted from said fluorescent substance.

5. The substance according to claim 1, wherein the radius of said M is smaller than that of Sr, so as to red shift the wavelength of lights emitted from said fluorescent substance.

6. The substance according to claim 1, wherein the preparation method of said fluorescent substance is selected from the following group: solid state reaction method, co-precipitation method, gel method and micro emulsion method.

7. The substance according to claim 1, wherein the preparation method of said fluorescent substance comprises:
performing a mixing process to mix raw materials, so as to form a mixture; and
performing a sintering process to sinter said mixture.

8. The substance according to claim 7, wherein said sintering process further comprises a reduction step.

9. The substance according to claim 8, wherein the reduction temperature ranges from 1200° C. to 1700° C.

10. The substance according to claim 8, wherein the reduction time ranges from 4 hrs to 24 hrs.

11. The substance according to claim 8, wherein the environment for said reduction step comprises mixed hydrogen and nitrogen or mixed hydrogen and argon.

12. The substance according to claim 1, wherein said low voltage exciting source is selected from a group consisting of the following: carbon nanotube emitter (CNT), surface conduction electron emitter (SED), ballistic electron surface emitter (BSD), metal insulator metal emitter (MIM) and the modifications thereof.

13. The substance according to claim 1, wherein said low voltage exciting source is equal to or less than 1 kV.
